(19) United States
(12) Patent Application Publication
(10) Pub. No.: US 2024/0249542 A1
(43) Pub. Date: Jul. 25, 2024

(54) ELECTRONIC APPARATUS AND IMAGE PROCESSING METHOD

(71) Applicant: Lenovo (Singapore) Pte. Ltd., Singapore (SG)

(72) Inventor: Keiichi Yoshitomi, Kanagawa (JP)

(73) Assignee: Lenovo (Singapore) Pte. Ltd., Singapore (SG)

(21) Appl. No.: 18/390,152

(22) Filed: Dec. 20, 2023

(30) Foreign Application Priority Data
Jan. 20, 2023 (JP) 2023-007259

(51) Int. Cl. G06V 30/164; G06V 30/146

(52) U.S. Cl. CPC G06V 30/164; G06V 30/147

(57) ABSTRACT

An electronic apparatus includes a processor configured to execute area extraction processing of extracting a character area including a character in an image, processing of applying dithering to an area other than the character area in the image, and emphasizing processing of emphasizing the character in the character area.

### CROSS-REFERENCE TO RELATED APPLICATIONS

This application claims priority to Japanese Patent Application No. 2023-007259 filed on Jun. 20, 2023, the contents of which are hereby incorporated herein by reference in their entirety.

### BACKGROUND OF THE INVENTION

### Field of the Invention

The present invention relates to an electronic apparatus and an image processing method.

### Description of the Related Art

A display using electronic paper has been developed. An electronic paper display is used for text editing, programming, and the like.

A refresh rate of an electronic paper display is lower than a refresh rate of a liquid-crystal display or the like. A general electronic paper display has a function of performing dithering to reduce gray scale resolution of an image. Accordingly, a refresh rate of an electronic paper display can be increased.

Japanese Unexamined Patent Application Publication No. 2015-2545 discloses an electronic paper terminal capable of reducing the number of refresh operations by changing an order in which images are displayed into an order in which an afterimage is less likely to occur.

A refresh rate of an electronic paper display can be increased by performing dithering. However, since the dithering is evenly applied to an entire image, it becomes difficult to read fine characters.

### SUMMARY OF THE INVENTION

An object of the present invention is to provide an electronic apparatus and an image processing method capable of improving visibility of characters in an image to which dithering has been applied.

A first aspect of the present invention is an electronic apparatus including a processor configured to execute area extraction processing of extracting a character area including a character in an image, processing of applying dithering to an area other than the character area in the image, and emphasizing processing of emphasizing the character in the character area.

In the first aspect of the present invention, the processor may binarize the character area in the emphasizing processing.

In the first aspect of the present invention, the processor may execute processing of emphasizing an edge in the emphasizing processing.

In the first aspect of the present invention, the processor may extract the character from the character area in the emphasizing processing, generate a graphic image of the character, and superimpose the graphic image on the character area.

A second aspect of the present invention is an image processing method including causing a processor to execute a step of extracting a character area including a character in an image, a step of executing dithering on an area other than the character area in the image, and a step of emphasizing the character in the character area.

The above-described aspects of present invention can improve the visibility of characters in an image to which dithering has been applied.

### BRIEF DESCRIPTION OF THE DRAWINGS

FIG. 1 is a diagram illustrating a hardware configuration example of an electronic apparatus according to one or more embodiments.

FIG. 2 is a diagram illustrating a functional configuration example of an electronic apparatus according to one or more embodiments.

FIG. 3 is a flowchart illustrating an operation example of the electronic apparatus according to one or more embodiments.

FIG. 4 is a diagram illustrating an example of an image in one or more embodiments.

FIG. 5 is a diagram illustrating an example of an image in one or more embodiments.

FIG. 6 is a diagram illustrating an example of a histogram of a pixel value of an image in one or more embodiments.

FIG. 7 is a diagram illustrating an example of an image in one or more embodiments.

FIG. 8 is a diagram illustrating an example of an image to which dithering of the related art has been applied.

### DETAILED DESCRIPTION OF THE INVENTION

Hereinafter, one or more embodiments of the present invention will be described with reference to the drawings.

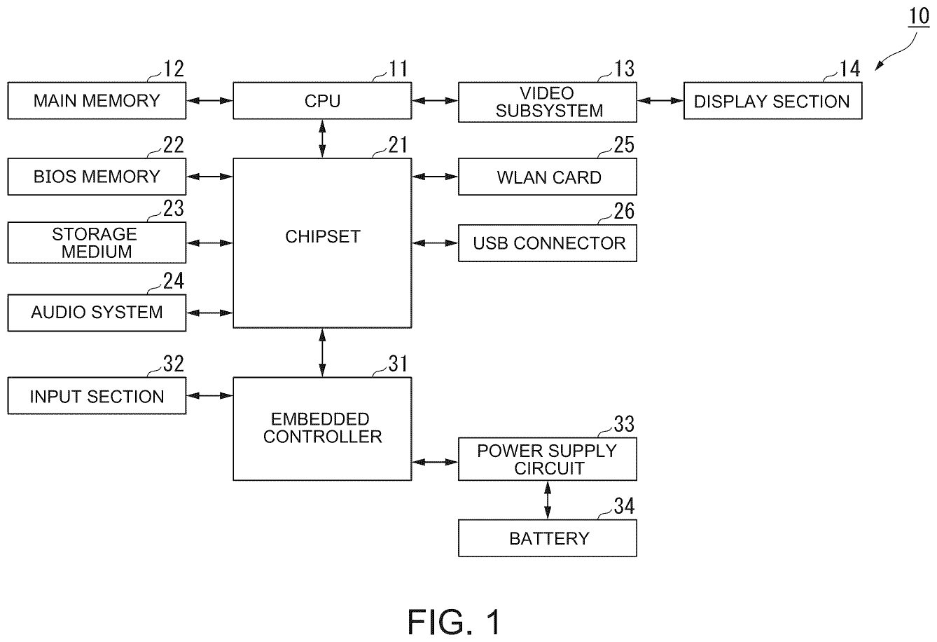

A hardware configuration example of an electronic apparatus 10 according to one or more embodiments will be described with reference to FIG. 1. FIG. 1 is a block diagram illustrating an example of the hardware configuration of the electronic apparatus 10.

The electronic apparatus 10 includes a CPU 11, a main memory 12, a video subsystem 13, a display section 14, a chipset 21, a BIOS memory 22, a storage medium 23, an audio system 24, a WLAN card 25, a USB connector 26, embedded controller 31, an input section 32, a power supply circuit 33, and a battery 34.

The CPU 11 executes various types of computing processing with program control and controls the entire electronic apparatus 10. For example, the CPU 11 executes processing based on programs of an operating system (OS) and a basic input output system (BIOS). The CPU 11 is an example of a processor.

The main memory 12 is a writable memory used as a read area for an execution program of the CPU 11 or as a work area for writing processing data of the execution program. The main memory 12 includes, for example, a plurality of dynamic random access memory (DRAM) chips. This execution program includes an OS, various drivers for operating hardware of peripheral equipment, various services/utilities, an application program, and the like.

The video subsystem 13 is a subsystem for realizing a function related to image display, and includes a video controller. The video controller processes a drawing instruction from the CPU 11 and writes the processed drawing information to a video memory, and reads the drawing information from the video memory and outputs the processed drawing information as drawing data (display data) to the display section 14.

The display section 14 is an electronic paper display and displays a display screen based on the drawing data (display data) output from the video subsystem 13.

The chipset 21 includes a controller for a universal serial bus (USB), a serial AT attachment (ATA), a serial peripheral interface (SPI) bus, a peripheral component interconnect (PCI) bus, a PCI-Express bus, low pin count (LPC) bus, and the like, and a plurality of devices is connected to the chipset 21. For example, the BIOS memory 22, the storage medium 23, the audio system 24, the WLAN card 25, the USB connector 26, and the embedded controller 31, which are described later, are included as a plurality of devices.

The BIOS memory 22 includes an electrically rewritable non-volatile memory such as an electrically erasable programmable read-only memory (EEPROM) or a flash ROM. The BIOS memory 22 stores, for example, a BIOS and the system firmware for controlling the embedded controller 31 and the like. The BIOS memory 22 is an example of a sub memory.

The storage medium 23 includes a hard disk drive (HDD), a solid state drive (SSD), and the like. For example, the storage medium 23 stores an OS, various drivers, various services/utilities, an application program, and various data.

A microphone and a speaker are connected to the audio system 24 (not illustrated), and the audio system 24 records, plays, and outputs sound data. The microphone and the speaker are built in the electronic apparatus 10 as an example.

The wireless local area network (WLAN) card 25 is connected to a network by a wireless LAN, and performs data communication. For example, when the WLAN card 25 receives data from the network, the WLAN card 25 generates an event trigger indicating that the data has been received. The USB connector 26 is a connector for connecting peripheral equipment using USB.

The input section 32 collectively indicates input devices (input equipment) included in the electronic apparatus 10. The input section 32 includes a keyboard, a mouse, and the like. The input section 32 outputs input information input by a user's operation to the embedded controller 31.

The power supply circuit 33 includes, for example, a DC/DC converter, a charge/discharge unit, an AC/DC adapter, and the like. For example, the power supply circuit 33 converts a DC voltage supplied from an external power supply such as an AC adapter (not illustrated) or the battery 34 into a plurality of voltages required for operating the electronic apparatus 10. In addition, the power supply circuit 33 supplies power to each unit of the electronic apparatus 10 based on control from the embedded controller 31.

The battery 34 is a secondary battery such as a lithium-ion battery, for example. When power is supplied to the electronic apparatus 10 from an external power supply, the battery 34 is charged via the power supply circuit 33. In a case where power is not supplied to the electronic apparatus 10 from an external power supply, the battery 34 outputs the accumulated power as operating power of the electronic apparatus 10 via the power supply circuit 33.

The embedded controller 31 is a one-chip microcomputer that monitors and controls various devices (peripheral devices, sensors, and the like) regardless of a state of a system of the electronic apparatus 10. The embedded controller 31 includes a CPU, a ROM, a RAM, a plurality of channels of A/D input terminals and a D/A output terminal, a timer, and a digital input/output terminal, which are not illustrated. The input section 32, the power supply circuit 33, and the like are connected to the digital input/output terminal of the embedded controller 31, and the embedded controller 31 controls operations thereof. In addition, the embedded controller 31 performs control such as a change of a clock frequency of the CPU 11 via the chipset 21.

The electronic apparatus 10 may be a portable apparatus such as a clamshell personal computer, a tablet terminal, or a smartphone, and an electronic paper display may be integrally attached to a chassis of the electronic apparatus 10. Alternatively, a device main body and an electronic paper display may be separated, as in a desktop personal computer. The electronic apparatus 10 according to one or more embodiments is applicable to all apparatuses including a CPU.

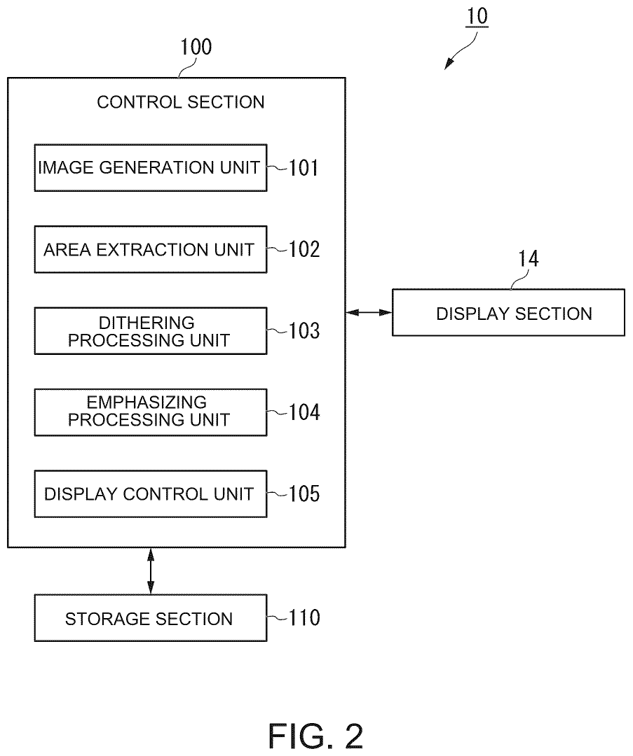

A functional configuration example of the electronic apparatus 10 will be described with reference to FIG. 2. FIG. 2 is a block diagram illustrating an example of the functional configuration of the electronic apparatus 10.

The electronic apparatus 10 includes a control section 100, the display section 14, and a storage section 110. The function of the control section 100 is realized by the CPU 11, the video subsystem 13, or by a combination of the CPU 11 and the video subsystem 13.

The storage section 110 stores a program executed by the control section 100, data used by the control section 100, data generated by the control section 100, and the like. A function of the storage section 110 is realized by the main memory 12, the storage medium 23, or a combination of the main memory 12 and the storage medium 23.

The control section 100 includes an image generation unit 101, an area extraction unit 102, a dithering processing unit 103, an emphasizing processing unit 104, and a display control unit 105. The image generation unit 101 generates an image. The area extraction unit 102 executes area extraction processing of extracting a character area including characters in the image generated by the image generation unit 101. The dithering processing unit 103 executes processing of applying dithering to an area other than the character area in the image generated by the image generation unit 101. The emphasizing processing unit 104 executes emphasizing processing of emphasizing characters in the character area. The display control unit 105 outputs the image, which the dithering and the emphasizing processing have been applied to, to the display section 14, and displays the image on the display section 14.

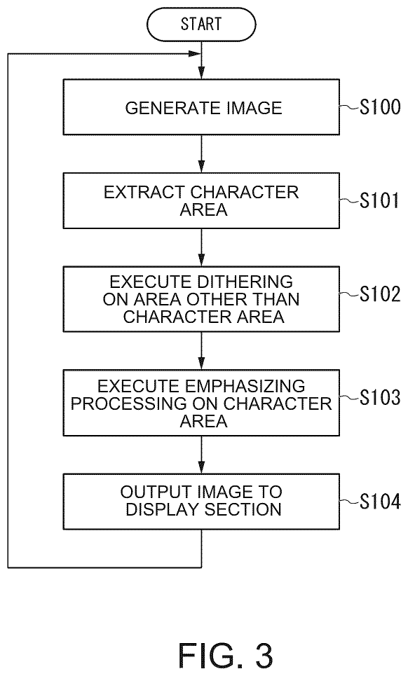

Processing executed by the electronic apparatus 10 will be described with reference to FIG. 3. FIG. 3 is a flowchart illustrating the operation of the electronic apparatus 10.

### Step S100

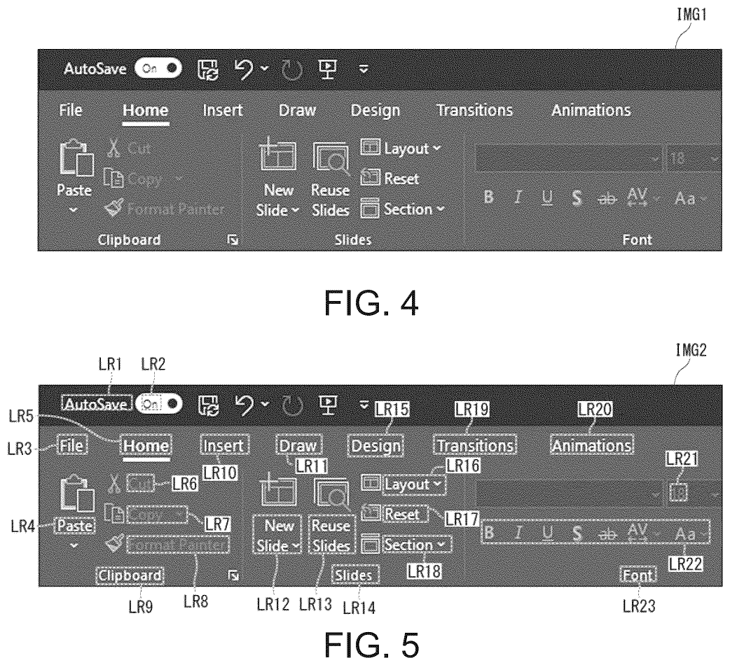

The image generation unit 101 acquires data including character (text) from the storage section 110. For example, the data is data generated by character editing software. The image generation unit 101 generates an image for display based on the acquired data. FIG. 4 illustrates an image IMG1 generated by the image generation unit 101.

### Step S101

The area extraction unit 102 executes the area extraction processing to extract one or more character areas from the image. For example, the area extraction unit 102 detects characters by executing optical character recognition (OCR) processing, and extracts a character area including the characters.

FIG. 5 illustrates an image IMG2 processed by the area extraction unit 102. The area extraction unit 102 extracts character areas LR1 to LR23.

### Step S102

The dithering processing unit 103 applies dithering to an area other than the character area in the image. In this case, the dithering processing unit 103 converts the processing target area to gray scale. Random dithering, sequence dithering, or the like can be applied as dithering algorithm.

### Step S103

The emphasizing processing unit 104 executes the emphasizing processing on the character area. For example, the emphasizing processing unit 104 executes the following processing to binarize a value of each pixel in the character area.

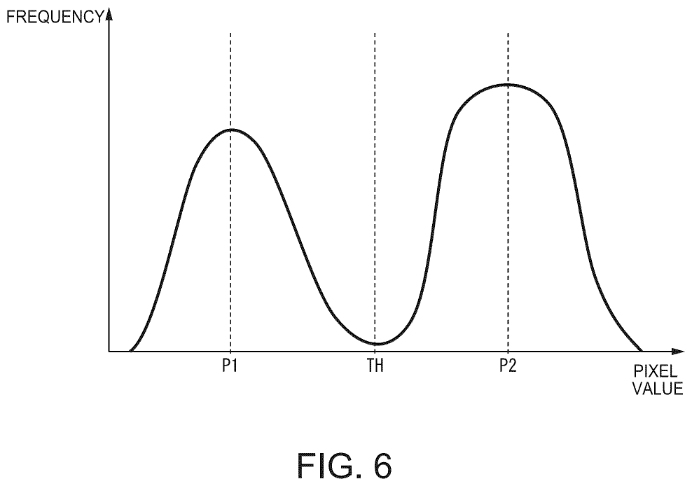

The emphasizing processing unit 104 generates a histogram of a pixel value for each character area. FIG. 6 illustrates an example of the histogram. A horizontal axis of a graph illustrated in FIG. 6 represents a pixel value, and a vertical axis of the graph represents the number (frequency) of a pixel having each pixel value. The emphasizing processing unit 104 detects a peak pixel value P1 and a peak pixel value P2 in the histogram. For example, the peak pixel value P1 is a pixel value having the highest frequency in pixels of characters, and the peak pixel value P2 is a pixel value having the highest frequency in pixels of a background.

The emphasizing processing unit 104 detects a pixel value TH between the peak pixel value P1 and the peak pixel value P2. For example, the pixel value TH is a pixel value in the valley between the two peaks of the histogram. The emphasizing processing unit 104 detects the pixel value TH for each character area. The emphasizing processing unit 104 uses the pixel value TH as a threshold value to binarize the value of each pixel in each character area.

### Step S104

The display control unit 105 outputs the image to the display section 14, and displays the image on the display section 14.

After step S104 is executed, step S100 is executed.

An order in which step S102 and step S103 are executed is not limited to an order illustrated in FIG. 3. After step S101 is executed, step S103 and step S102 may be executed in this order.

The dithering processing unit 103 may perform dithering on an entire image. In that case, the emphasizing processing unit 104 executes the emphasizing processing on a character area to which dithering has been applied.

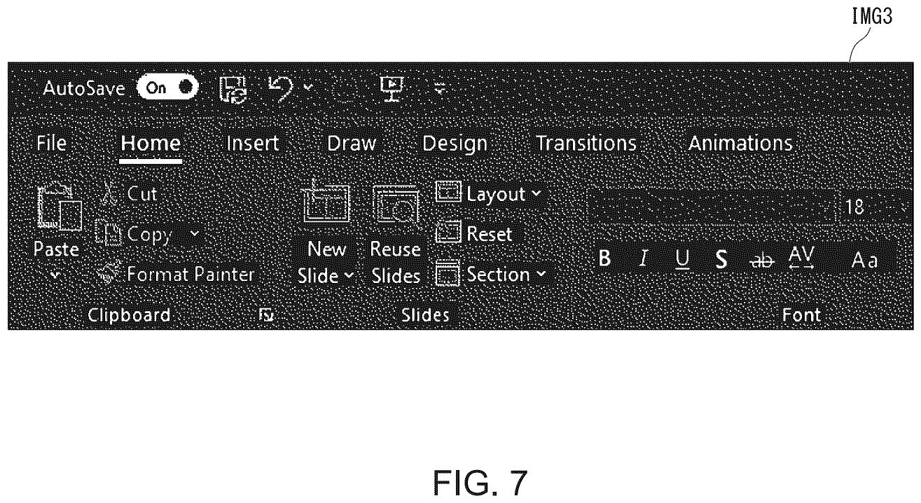

FIG. 7 illustrates an image IMG3 processed by the dithering processing unit 103 and the emphasizing processing unit 104. The dithering processing unit 103 applies dithering to the area other than the character areas LR1 to LR23 in the image IMG2 illustrated in FIG. 5. The emphasizing processing unit 104 executes the emphasizing processing on the character areas LR1 to LR23 in the image IMG2. The image IMG3 is an image generated by applying the dithering and the emphasizing processing to the image IMG2.

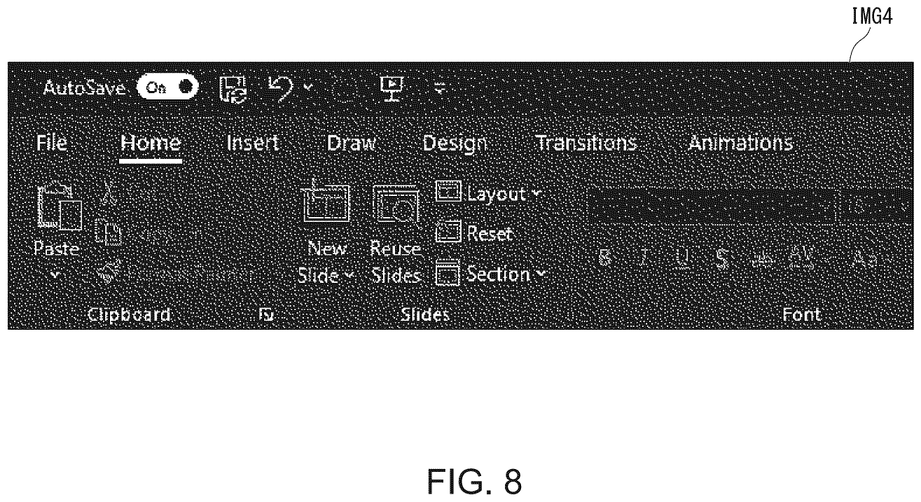

FIG. 8 illustrates an image IMG4 generated by evenly applying dithering to the entire image IMG1 illustrated in FIG. 4. Since dithering is also applied to the character area, it is difficult to read fine characters. On the other hand, in the image IMG3 illustrated in FIG. 7, since the emphasizing processing is applied to the character area instead of the dithering, visibility of characters is improved as compared with that of the image IMG4.

As described above, the area extraction unit 102 extracts a character area including characters in an image. The dithering processing unit 103 applies dithering to an area other than the character area in the image. The emphasizing processing unit 104 emphasizes characters in the character area. As a result, the electronic apparatus 10 can improve visibility of characters in the image to which dithering has been applied.

The emphasizing processing unit 104 may apply processing of emphasizing an edge to the character area (edge emphasizing), and then binarize a value of each pixel in the character area. By applying edge emphasizing to the character area, a boundary between characters and a background is clarified. Therefore, an outline of the characters in the binarized character area is emphasized, and the visibility of the characters is improved.

The emphasizing processing unit 104 may extract characters from the character area and generate a graphic image of the characters. For example, the graphic image is an image of binarized characters. The graphic image may be a template image prepared in advance for each character. The emphasizing processing unit 104 may make the characters in the graphic image thicker than the characters in the original image. The emphasizing processing unit 104 may superimpose the generated graphic image on the character area. Since the characters of the graphic image are displayed in the character area, the visibility of the characters is improved.

Although one or more embodiments of the present invention has been described in detail with reference to the drawings above, a specific configuration is not limited to the above-described one or more embodiments, and includes design changes and the like within a range not deviating from the gist of the present invention.

### DESCRIPTION OF SYMBOLS

10 electronic apparatus
11 CPU
12 main memory
13 video subsystem
14 display section
21 chipset
22 BIOS memory
23 storage medium
24 audio system
25 WLAN card
26 USB connector
31 embedded controller
32 input section
33 power supply circuit
34 battery
100 control section
101 image generation unit
102 area extraction unit
103 dithering processing unit
104 emphasizing processing unit
105 display control unit
110 storage section

What is claimed is:

1. An electronic apparatus comprising:
a processor configured to execute area extraction processing of extracting a character area including a character in an image, processing of applying dithering to an area other than the character area in the image, and emphasizing processing of emphasizing the character in the character area.

2. The electronic apparatus according to claim 1,
wherein the processor binarizes the character area in the emphasizing processing.

3. The electronic apparatus according to claim 2,
wherein the processor executes processing of emphasizing an edge in the emphasizing processing.

4. The electronic apparatus according to claim 1,
wherein the processor extracts the character from the character area in the emphasizing processing, generates a graphic image of the character, and superimposes the graphic image on the character area.

5. An image processing method comprising:
causing a processor to execute:
a step of extracting a character area including a character in an image;
a step of applying dithering to an area other than the character area in the image; and
a step of emphasizing the character in the character area.
